(19) United States
(12) Patent Application Publication
(10) Pub. No.: US 2016/0023112 A1
(43) Pub. Date: Jan. 28, 2016

(54) SYSTEM FOR UPDATING ATTRIBUTES

(71) Applicant: KING.COM LIMITED, St. Julians, MT (US)

(72) Inventor: Lucian-Andrei ONISCU, Bucharest (RO)

(21) Appl. No.: 14/339,573

(22) Filed: Jul. 24, 2014

(51) Int. Cl. A63F 13/52

(52) U.S. Cl. CPC A63F 13/52

(57) ABSTRACT

A system is provided for providing a computer implemented game having a plurality of game elements which in use are displayed on display. The system comprises an input configured to receive an input from a user; a first game part configured to be responsive to said input and configured to control a first part of a game area; a second game part configured to be responsive to information from said first game part and configured to control a second part of the game area, said first part of said game area being different to said second part of said game area; and a view function configured to perform a view function for the respective game parts to cause an image to displayed comprising said first and second game areas and game elements there on.

### FIELD OF THE INVENTION

Some embodiments may relate to algorithms for controlling a user interface responsive to user engagement with an interface of a computer device. The embodiments may have particular, but not exclusive application in the field of computer implemented applications including for example games, in an online or offline environment, and computing devices therefor.

### BACKGROUND OF THE INVENTION

Computer implemented games are a well-known category of games that allow a player to interact with a computing device to cause the processor to perform certain functions and typically display a result on a screen or other display device.

Different types of games have evolved from classical arcade games in to games that can be played on a handheld device such as a smartphone, tablet or personal computer. Some games are also connected to the Internet and the player can play against or compare score with other users in multiplayer mode.

A common genre of casual games is so-called match games. This is a type of tile-matching game where the player manipulates tiles or game objects according to a matching criterion.

### SUMMARY OF THE INVENTION

According to a first aspect, there is provided a system for providing a computer implemented game having a plurality of game elements which in use are displayed on display, said system comprising: an input configured to receive an input from a user; a first game part configured to be responsive to said input and configured to control a first part of a game area; a second game part configured to be responsive to information from said first game part and configured to control a second part of the game area, said first part of said game area being different to said second part of said game area; and a view function configured to perform a view function for the respective game parts to cause an image to displayed comprising said first and second game areas and game elements there on.

The first and second game parts may be game models. The first part of the game area may have a plurality of a first game elements, said first game part may be configured to update game element information associated with at least one of the first game elements. The first game part may be configured to determine if said input comprises a valid input and if so to update game element information associated with at least one first game element.

A valid input may comprise an input linking a plurality of first game elements in accordance with a set of rules. The first game part may be configured to generate an output to said second game part responsive to a valid input, said output being dependent on one or more characteristics of the valid input. The second part of the game area may have a plurality of a second game elements, said second game part may be configured to update game element information associated with the second game elements.

The second game part may be configured to update game element information associated with said second game elements in response to said output from said first game part. The view function may be configured to cause a displayed image to be updated in response to an indication of the updated game element information from the second game part. The view function is may be configured to cause a displayed image to be updated in response to an indication of the updated game element information from the first game part.

The first game part may be further configured to generate a new first game element in response to the input. The second game part may be further configured to generate a new second game element in response to the information from the first game part.

According to a second aspect, there is provided a method for providing a computer implemented game having a plurality of game elements which in use are displayed on display, said method comprising: receiving an input from a user; controlling a first part of a game area by a first game part in response to said input; controlling a second part of the game area by a second game part in response to information from said first game part, where said first part of said game area being different to said second part of said game area; and perform a view function for the respective game parts to cause an image to displayed comprising said first and second game areas and game elements there on.

The first part of the game area may have a plurality of a first game elements, the method may further comprise: updating game element information associated with at least one of the first game elements by the first game part. The method may further comprise: determining by the first game part if said input comprises a valid input and if so to updating game element information associated with at least one first game element. The method may further comprise: generating by the first game part an output to said second game part responsive to a valid input, said output being dependent on one or more characteristics of the valid input.

The second part of the game area may have a plurality of a second game elements, the method may further comprise: updating game element information associated with the second game elements by the second game part. The method may further comprise: updating by the second game part, game element information associated with said second game elements in response to said output from said first game part.

The method may further comprise: causing a displayed image to be updated in response to an indication of the updated game element information from the second game part. The method may further comprise: causing a displayed image to be updated in response to an indication of the updated game element information from the first game part. The method may further comprise: generating by the first game part a new first game element in response to the input. The method may further comprise: generating by the second game part a new second game element in response to the output from the first game part.

### BRIEF DESCRIPTION OF THE DRAWINGS

FIG. 1 shows an example user device in which some embodiments may be provided;

FIG. 2 shows an example system in which some embodiments may be provided;

FIG. 3a to f show examples of game boards displayed to the user in varying configuration;

FIG. 4 is a schematic diagram showing the modules and functions associated with carrying out the operating of embodiments;

FIG. 5 is a flow diagram depicting the method steps associated with embodiments;

FIG. 6 is a conceptual diagram depicting the layers of some embodiments; and

FIGS. 7a and 7b show examples of a partial section of a game board.

### DETAILED DESCRIPTION OF THE INVENTION

In the following description of various implementations of the invention, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

The terms user and player are used interchangeably throughout this document and no specific meaning is intended using one or the other unless the context suggests otherwise.

A person skilled in the art will realise that the different approaches to implementing the game is not exhaustive, what is described herein are certain preferred embodiments. It is possible to implement the way in a number of variations without departing from the spirit or scope of the invention.

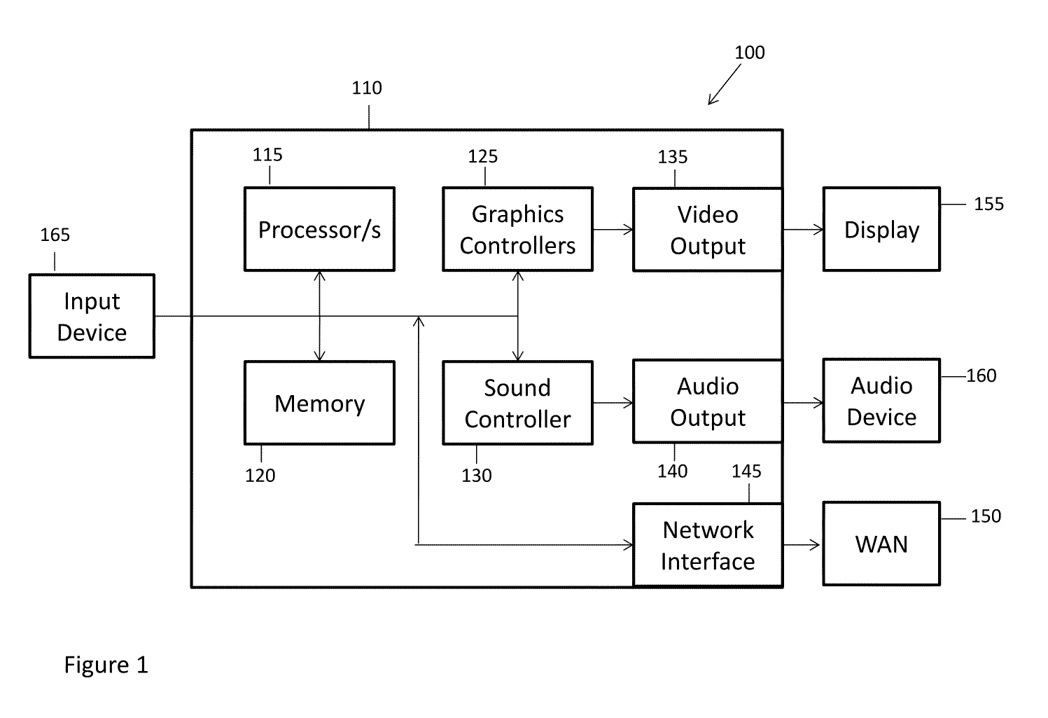

A schematic view of a user device 100 according to an embodiment is shown in FIG. 1. All of the blocks shown are implemented by suitable circuitry. The blocks may be implemented in hardware and/or software. The user device may have a control part 110. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

It should be appreciated that in some embodiments, the controller may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

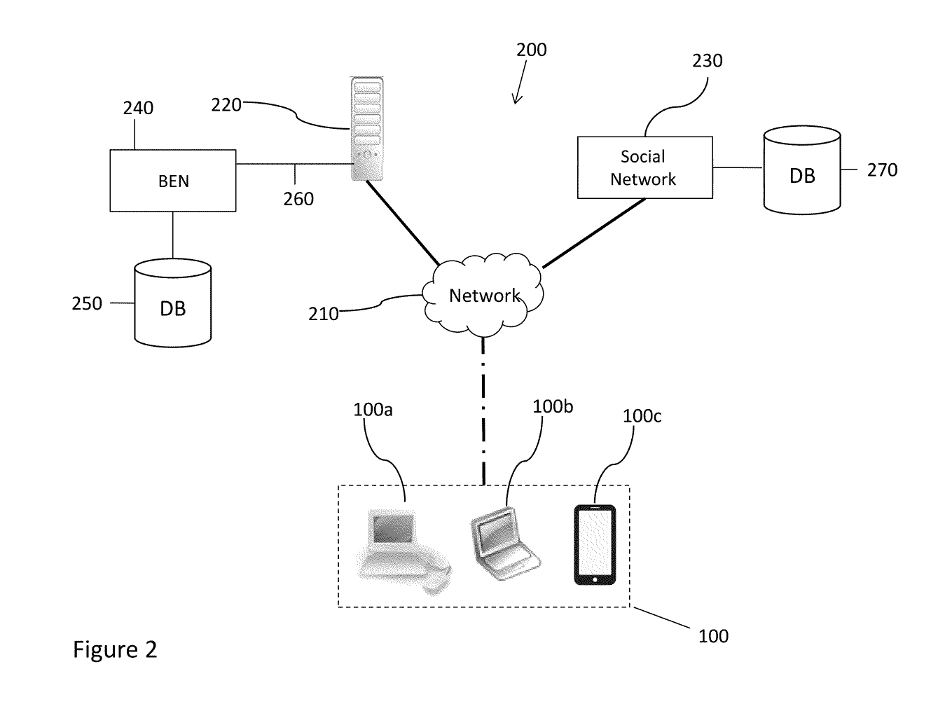

FIG. 2 schematically shows a system 200 according to an embodiment. The system 200 comprises a server 220 which may store or be in communication with database 250 which may be, in some embodiments, be connected to a back end infrastructure (BEN) of game player's details, profiles, statistics etc. In practice, one or more databases 250 may be provided. Where more than one server 220 is provided, the database(s) 250 may be provided in one database 250 or across two or more servers. The server 220 may also have a games data function. This may comprise one or more units of memory to store the computer game program, user behaviour data and a processor 115 to run the games program and process the user behaviour data.

The server 220 may communicate via, for instance, the internet 210 to one or more client or user devices 100, shown in FIG. 2 by way of example as user devices 100a, 100b and 100c, and may further provide connections to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 320 may handle some elements of the game in some embodiments. By way of example only, a Java game applet may be provided to the user device 200 and the locally running Java applet will generate, for example, the graphics, sounds, and user interaction for the game play on the user device. Some data may be fed back to the server to allow interaction with other players 305. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as stand-alone games on the user device.

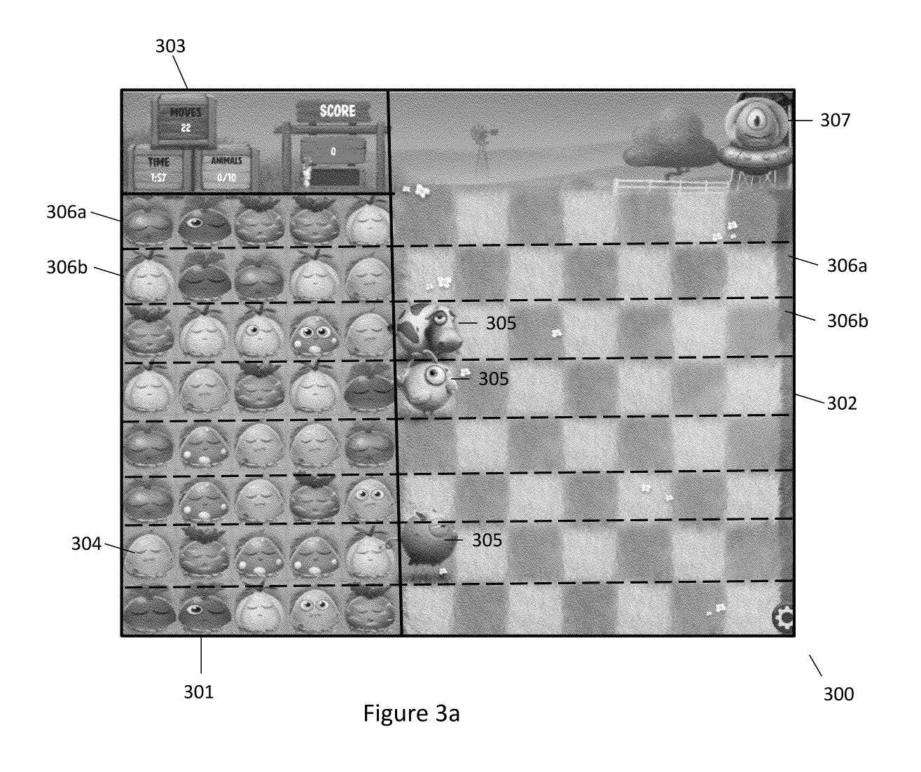

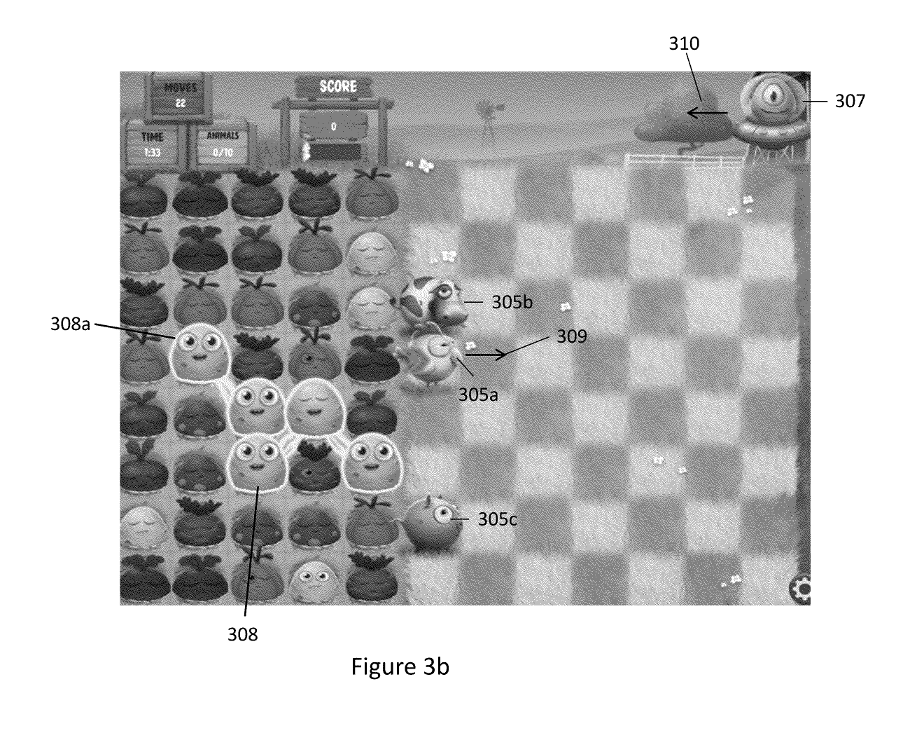

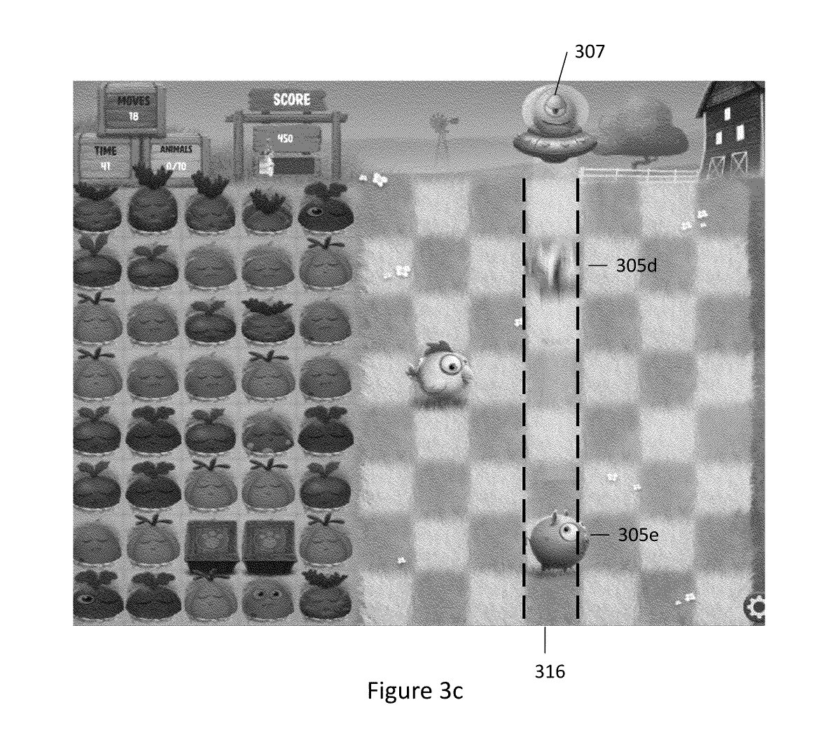

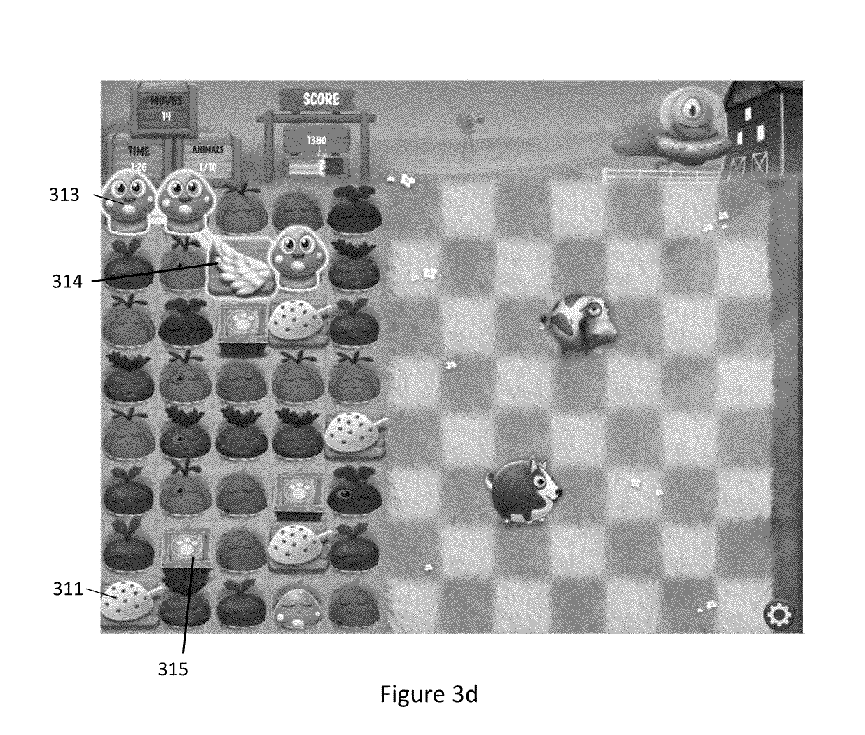

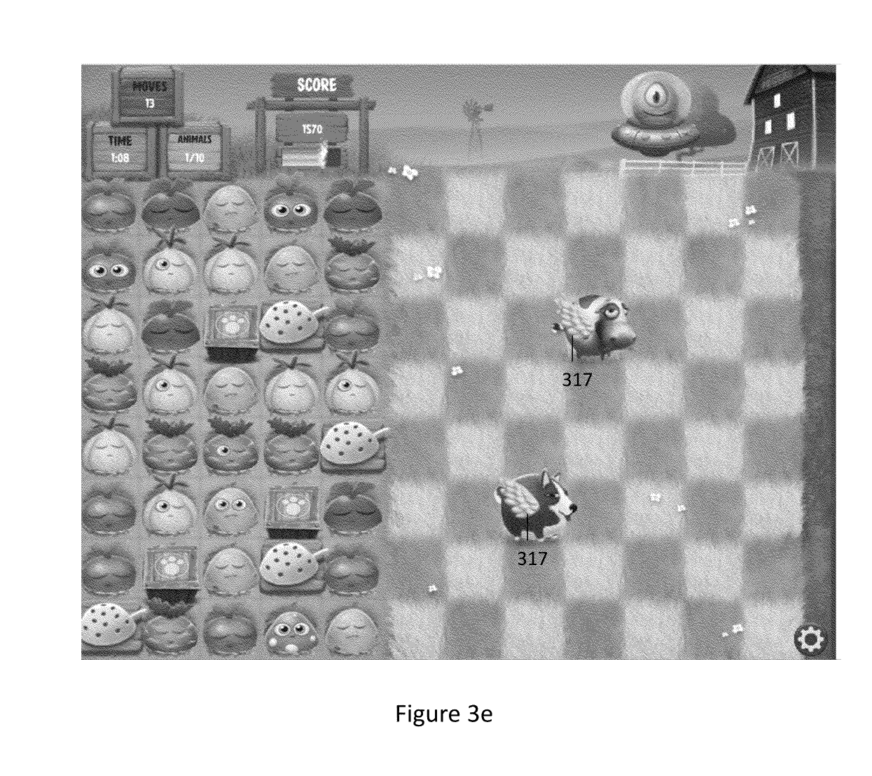

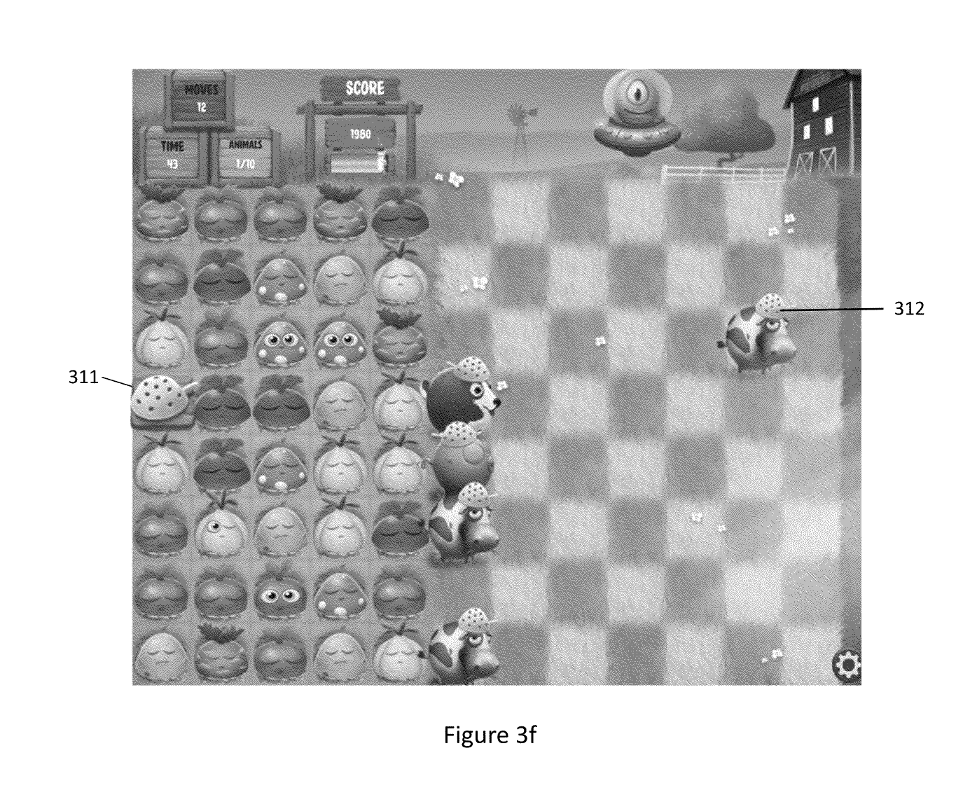

Reference is made to FIG. 3a which shows a two part game board 300. The game board 300 has a first part of the game board 301 having first game elements 304 (vegetables) arranged in a tiled formation. The game board 300 has a second part 302 of the game board 302 having second game elements (animals) 305 arranged in lanes. The lanes and rows of tiles may form corresponding rows for example 306a and b etc. The game board 300 may further have an information display section 303 for the display of information such as the time taken, number of moves, number of second game elements that have reached the end of their row and a score. The second part 302 may further comprise a game element which is a game element remover 307.

The user is able to interact with the first part 301 of the game board by matching three or more first game elements 304. The actions by the user with respect to the first part 301 of the board are used to control the movement of second game elements 305 (for example animals) in the second part 302 of the board. The aim of the game is to control the movement of the game elements 305 in the second part of the game, for example to move the game elements 305 by a given amount. Thus consideration needs to be given to the position of the second game elements 305 in the second part of the game board, their status and the position and status of a game element remover 307 (flying saucer, for example Marvin).

In some embodiments, the consequent actions in the second part of the game board may be rewarded by a greater amount than the actions in the first part of the game board.

Embodiments may be described in relation to a game. In an example of the game, matching three or more vegetables on the first part of the board may cause the animals on the second part of the board to move. For example, the tiles and lanes of the first and second parts of the game board may be arranged in corresponding rows. The board may also be arranged in columns. When three or more vegetables are matched, any animal in the same row as a matched vegetable is moved. The animal may be moved a number of times as the number of matched vegetables in the corresponding row. The flying saucer 307 additionally may move across columns in response to a user turn being taken (vegetable matched). The flying saucer may remove an animal in the same column as the flying saucer. The aim may be to move as many as possible of the animals to the end of the row and off the game board without the animals being removed or abducted by the flying saucer. It will be appreciated that this game is by way of example only and may have additional or different rules in other embodiment.

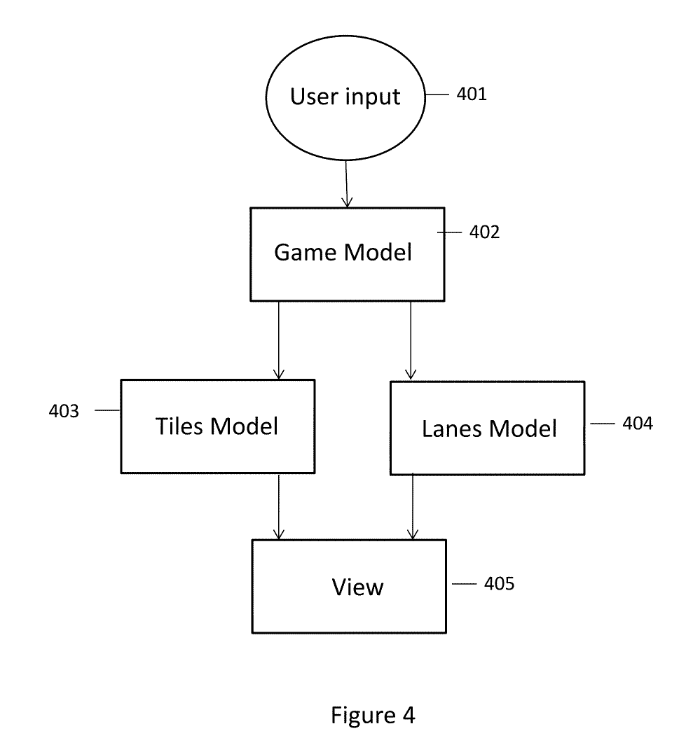

FIGS. 3b to 3f show examples of configurations of the game board 300 that may occur during a game. The provision of the game board may be provided by one or modules. FIG. 4 shows an example of the models and functions that may be implemented to provide the game board 300.

Reference is made to FIG. 4 which schematically shows an embodiment. The embodiment has a game model 401, a tile model 402, a lane model 403 and a view function 404. Each of these parts may be regarded as being a software module.

The game model 401 may receive a user input. This is where the user interaction with a touch screen and/or by using a pointer is captured. The user input is, in this example, to match together three or more first game elements displayed in the first part (tile part) of the game board and accordingly movement of the pointer/users finger relative to the display is captured.

The game model 402 will process the information associated with the user input and will provide information to the tiles model 403 to indicate which tiles having associated first game elements have been selected by the user and in which order. The game model 402 may determine whether the user input is allowed for example if the selected first game elements match and if 3 or more game elements are selected.

The tile model 403 will process the information and provide an output to the lanes model 404. Each game element may be associated with game element information. The tile model 403 may process the information from the game model 402 and update game element information associated with the first game elements on the first part of the board. For example, the selected first game elements may for example be replaced by new first game elements on the first part of the board. Additionally, new first game elements may be created for the first part of the game board in dependence on the user input. In some examples a selection of four or more first game elements may result in bonus game elements being generated.

Examples of bonus first game elements and their associated actions that may be carried out in response to user input may be as follows in some embodiments.

Wings—generated when 8 or more first game elements are selected may provide immunity of a second game element to holes and additional moves;

Strainer—generated when 6 or 7 first game elements are selected may provide immunity of a second game object from abduction;

Box—generated when 4 or 5 first game elements are selected may provide an additional second game element.

The actions associated with the bonus game elements may be carried out in response to the bonus game element forming part of a selection of first game elements.

The actions carried out on the first part of the game board, may control actions for second game board. The tile model 403 may determine whether the second game board is affected—for example whether the user input is such to cause action on the second game board. If this is the case, the tile model 403 may provide an output to the second game board. This output will for example provide an indication of which second game elements of the second part of the game board are affected and how. The output may cause the lanes model to update game element information associated with one or more of the second game elements of the second part of the game board.

In one example, the first part of the game board and the second part of the game board may have corresponding rows. The tile model may determine in which rows first game elements were selected by the user input and provide this information to the second part of the game board. This information may indicate that second game elements in the rows indicated by the information are to be moved. The information may also indicate how many of the first game elements were selected in a row and this may determine how far a second game element in a corresponding row is to be moved. Additionally, some first game elements may game element information indication that a selection of that first game element may result in a bonus action. New second game elements may for example be generated by the lanes model in response to the information. The lanes model may update game element information of the second game elements in response to the information. The lanes model may also update a second game element in response to a move be made (user input), for example Marvin may have move and/or abduct.

For example, the information from the tile model to the lanes model may control how many gusts of wind to trigger and the strength of the wind. The gusts of wind effectively control by how much a game element (animal) should move. The output of the tile mode also provides information indicating if any new game elements (animals) are generated in the second part of the game board and their position. The tile model will also determine if any of the game elements (animals) are to be provided with special characteristics which modify the behavior of the game elements (animals) in some circumstances. The special characteristics are the protection against removal from the board (alien abduction) and an ability to bypass an obstacle (mud hole). The tile model deals with the matching algorithms, chain validation, tiles and power-up generation, reshuffle and tiles falling. This is controlled by the user input.

This data or information from the tiles model is provided to the lanes model which then modifies the second part of the game board in dependence on that input. The lane model deals with the animal generation, moving of the animals and kidnap, the mud holes, the gusts of wind and Marvin actions

The view function 405 is for using the data provided by the tile 403 and lane 404 models to provide an image for display. Every visual object (game element, for example tile, animal, gust of wing etc) has a data object (comprising game element information) associated with it. The data object will know nothing about the view object, since a proxy uses the data objects without the view. Whenever a model class (tiles or lanes model) changes something in a data object, and that change needs to be reflected in the view, there will be a notification sent on a channel. The view function monitors the channel and the view function will identify the view object that is associated with the changed data object. The view function will ensure that the view object is updated in accordance with the new data. The view monitors what the model does and changes the viewed object accordingly.

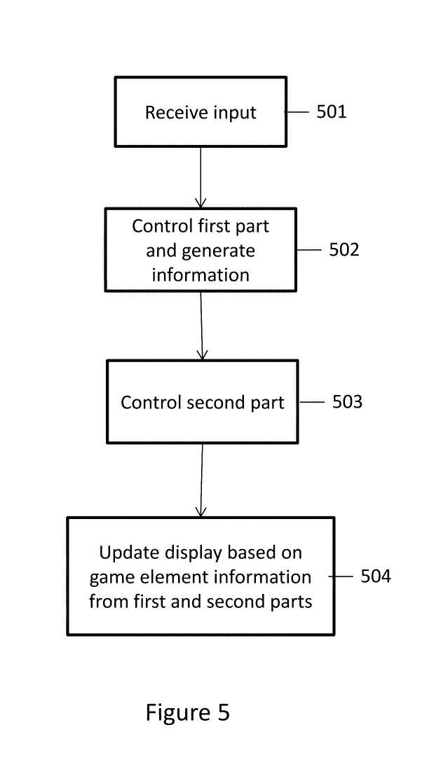

FIG. 5 is a flow diagram showing the method steps that may be carried out in accordance with some embodiments and the model of FIG. 4.

At step 501 user input may be received indicating a selection of first game elements by a user. It will be appreciated that the user input may be checked to determine whether it is valid user input, for example by a game model 402. For example it may be determined whether game elements selected by a user are the same and the number of selections. It will be appreciated that this checking of the user input may be carried out with the user input, for example only game elements that are selectable (for example match or are adjacent) are made selectable to a user.

At step 502, the user input information is used to control a first part of the game board and information relating to the second part of the game board is generated. For example, the user input information may be provided to a tile model 402. The tile model may determine actions to be carried out in response to the user input. For example, the tile model may determine that game elements are to be removed and/or added, game elements are to be moved. The tile model may update game elements information of the first game elements to reflect these actions. The tile model may additionally determine that the user input affects the second game board. If the user input triggers an action on the second game board, information relating to the user information processed by the tile model may be provided to the lanes model.

At step 503, information relating to the second part of the game board is used to update game elements of the second game board. For example, information relating to which rows first game elements were selected in is provided to the lanes model and second game elements in those rows are moved accordingly.

Additionally, information relating to further or bonus second game elements to be generated in response to the user input is provided. For example if a new second game element is to be generated or if the existing second game elements are to be modified or updated to have a new characteristic such as a higher speed or protection from another game action.

At step 504, information relating to updated game element information is provided to a view function that updates the display.

FIGS. 3b to 3f will now be described in more detail related to the provision of the game board by the module and functions of FIG. 4 and the display method of FIG. 5.

FIG. 3b shows an example of using the first game elements 304 on the first part 301 of the game board to control the movement of second game elements 305 on the second part of the board 302. In operation, a user may select three or more of the first game elements. In the example of FIG. 3b, a user input may comprise the selection of four game elements shown at 308. Of the selected game elements (in this case, potatoes) two of the first game elements are in the third row from the bottom, two of the first game elements are in the fourth row from the bottom and one first game element is in the fifth row from the bottom. A second game element 305c is in the second row from the bottom. A second game element 305a is in the fifth row from the bottom and a second game element 305b is in the sixth row from the bottom.

In response to the selection of the four first game elements 308 in the first part of the game board, second game elements of the second part of the game board may be moved. In this case any of the second game elements in a row of the second part of the game board corresponding to a row of the first game board containing a selected first game element will be moved. In this case, second game element 305a is in the same row as a selected first game element 308a and is moved in the direction of the arrow 309. As there is one selected game element 308a in the corresponding row, the second game element 305a is to be moved one column (one position) in response to the selection. No first game elements are selected in the rows corresponding to the second game elements 305b and 305c and these are not moved.

In examples, the user input selection of 308 may be processed by a game module and provided to a tile model that controls the first part of the game board. The tile model may determine the actions to be taken in response to the selection, for example to remove the selected first game objects. The tile model may also provide information identifying the rows in which the first game objects are selected and number of game objects selected in each row to a lane model. The lane model may control the second part of the game board. The lane model may determine from the information from the tile model, which of the second game elements are to be moved and by how much.

The tile model and the game model may update game element information for the first game elements and second game elements respectively. For example, the tile model may update game elements to remove the selected game elements. The lanes model may update the game element information of the second game element 305a to change the position of the game element 305a to one column to the right.

After a user input has indicated a selection of three or more first game elements, the game element remover 307 may also be moved. For example, the game element remover 307 may be moved one column to the left as indicated by arrow 310. It will be appreciated that the game element remover 307 may be a game element and may be associated with game element information including position. The lane model may update the game element information of the game element remover 307 to have a position one column to the left of the current position.

The tile model and the lanes model may provide the updated game element information to the view function, which may then update the view. For example in FIG. 3b, the second game element 305a may be moved one column to the right, the game element remover 307 may be moved one column to the left and the selected game elements 308 may be removed and replaced with other game elements.

In some embodiments, where a second game element is in the same column as the game element remover 307, the lane model may modify the game element in the same column to be removed. This may for example include a display graphic of the game element being abducted by the game element remover 307. This is shown for example in FIG. 3c.

In FIG. 3c, a second game element 305d may be in the same column as the game element remover 307. The lane model may determine that the second game element 305d and the game element remover 307 have game element information referring to the same column 316. The lane model may update game element information of the second game element 305d to remove the game element 305d. This may for example include an indication of an abduction graphic as shown by the blurred nature of the game element 305d.

It will be appreciated that in this example there is another second game element in the same column 316 as the game element remover 307. In this case, the lane model may determine that the game element in the row closest to the game element remover 307 is to be updated to have the abduction graphic. The lane model may provide the updated game element information to the view function which may display the abduction graphic and update the game board 300 to remove the game element 305d.

Selections comprising four or more first game elements may generate new first game elements or bonus first game elements. Bonus first game elements may be in the form of a first game element associated with an action in addition to moving a second game element on the second game board. These bonus game elements may be generated by the tile model in response to four or more first game objects being selected and may be used to carry out an action when selected as part of a selection of first game objects. FIG. 3d shows an example of various bonus first game objects.

The first part 301 of the game board of FIG. 3b shows three types of bonus game elements—a first bonus game element 314, a second bonus game element 311 and a third bonus game element 315.

The first bonus game element 314 may be depicted as a pair of wings, the second bonus game element 311 may be depicted as a strainer or colander and the third bonus game element 315 is depicted as a box with a paw print. When any of these bonus game elements are selected as part of a user input, the bonus game element may indicate that an additional action is to be carried. On selection of a user input, the game model may determine whether one of the selected first game elements is a bonus game element and provide this information to the tile model. The tile model may determine the action to be carried out and in some cases indicate this to the lane model. The lane model may update the game element information of the second game elements accordingly. The tile model may in some cases update the game element information of the first game elements accordingly.

The number of first game elements selected may be used by the game model or the tile model to determine whether any bonus game elements are to be generated. For example if four or five first game elements are selected, the third bonus game element (box with paw print) 315 may be generated by the tile model. If six or seven first game elements are selected, the second bonus game element (strainer) 311 may be generated by the tile model. If eight first game elements are selected, the first bonus game element (wings) 314 may be generated by the tile model. It will be appreciated that the tile model will generate the bonus game element in dependence on the game model and provide information to the view function to allow the bonus game element to be displayed to a user.

The subsequent selection of a bonus game element may result in an action in dependence on the type of bonus game element. For example, if a third bonus game element (box with paw print) 315 is selected, a new second game element may be generated. The tile model may determine that the third bonus game element is selected and provide information to the lanes model. The lanes model may generate a new second game element and provide information about the new second game element to the view function to allow it to display the new second game element.

FIG. 4d shows the selection of four first game elements 305 including a first bonus game element (wings) 314. In response to the selection of the first bonus game elements 314, the tile model may provide information of the action associated with the first bonus game element 314 to the lanes model. The lanes model may then update game element information of the second game elements to reflect the action. In this example, the second game elements are provided with wings in addition to their existing display. This is shown in FIG. 3e at 317. The updated game element information providing the wings is provided to the view function which displays the second game elements as having wings 317.

The wings 317 may additionally provide a second game element with enhanced characteristics. For example, instead of moving one column in response to a first game element selected in a corresponding column, the winged second game element may move two. Additionally, further embodiments of the game may include obstacles in the rows for the second game elements, for example holes into which the second game elements may disappear. The wings may allow the second game element to pass over the holes. The lane model may modify the game element information of the second game elements to reflect this.

In response to a selection of a second bonus game element 311 (strainer), for example where four game elements are selected including a second bonus game element 311, the tile model may provide information of the action associated with the second bonus game element 311 to the lanes model. The lanes model may then update game element information of the second game elements to reflect the action. In this example, the second game elements are provided with strainers in addition to their existing display. This is shown in FIG. 3f at 312. The updated game element information providing the strainer is provided to the view function which displays the second game elements as having strainers 312.

The wings 312 may additionally provide a second game element with enhanced characteristics. For example, the strainer may make a second game element immune to being removed by the game element remover 307. The lanes model may modify the game element information of the second game elements to reflect this. For example, when the lanes model determines that the game element remover 307 is in the same column as a second game element, the lanes model may only update the game element information of the second game element to indicate an abduction graphic and to be removed if the second game element does not have a strainer 312. The presence of the strainer 312 may be indicated in the game element information.

It will be appreciated that FIGS. 3a to 3f may relate to the same game board, where game elements are in varying configurations.

Referring back to FIG. 4, in some embodiments the view function 405 may use a layer model. Each layer is like an invisible container that holds visual objects, and if all the objects in one layer need to be above the objects in another layer, changing the first layers index will achieve this. All layers occupy the entire game area, are invisible and will not catch user input. Their purpose is to keep the visual objects organized and on the right index.

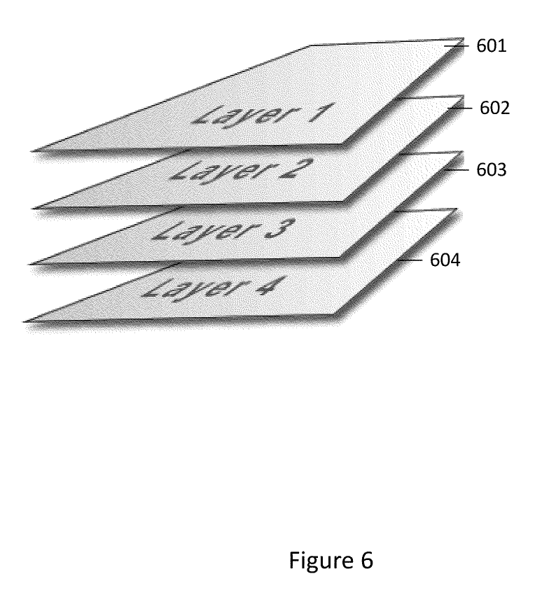

FIG. 6 shows an example of a 4 layer display. FIG. 6 comprises a first or top layer 601, a second layer 602, a third layer 603 and a fourth or bottom layer 604. Visual objects in the top layer will be displayed on top of other visual objects in other layers. Visual objects in the second layer will be displayed below visual objects in the top layer, but above any further layers. Visual objects in the third layer will be displayed below visual objects in the top and second layer, but above any further layers. Visual objects in the bottom layer will be displayed below visual objects in all the other layers. It will be appreciated that the visual objects adhere to their layers until they are selected by a user input and then may be brought to the top layer. It will also be appreciated that four layers is by way of example only and more or fewer layers may be implemented.

In some embodiments, the order of the layers may be as follows:

1) The lowest layer that is covered by everything else is the Background;

2) Mud holes layer is above but covered by all the next layers;

3) Unselected tiles layer; Indexing techniques will be applied inside this layer to have everything set correctly;

4) Selected tiles layer is above them; All the selected and selectable tiles along with the tile links (small animated chains between the linked tiles) will be moved here during link creation; the unselected tile will occupy the lowest indexes so they appear beneath the linked tiles;

5) Gust of wind layer; the gusts of wind are above all the tiles;

6) Animal shadows; the animal entity is split in two: the animal and his shadow, and set on different layers;

7) Animal graphics layer;

8) Marvin layer; Marvin will appear above most layers in the game;

9) Rainbow dash layer;

10) Particle effects layer is above everything else and the particles will always be set above other in game elements;

11) Finally the settings buttons in the lower right corner are set above the game elements.

In some of the layers that have lots of game elements, like the tiles and animals layers. Some embodiments are arranged to avoid index errors. Index errors are where a game element is provided in the wrong level and so appears above another game element when it should be below or vice versa.

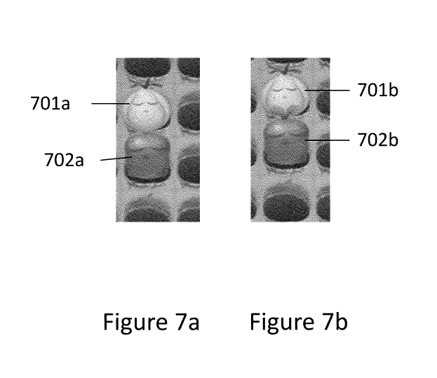

FIG. 7 shows an example of such an index error. FIG. 7a shows a section of the first part of the game board having a first game element (onion) 701a and a second game element (carrot) 702a showing an index error. In FIG. 7a, the onion is in a layer above the carrot and subsequently blocking the view of the carrot partially. FIG. 7b shows an example according to a corrected indexing (layers). FIG. 7b shows a section of the first part of the game board having a first game element (onion) 701b and a second game element (carrot) 702b. The carrot is on a higher layer than the onion and is no longer blocked from view.

In some embodiments, the index of those game elements are reset during certain stages of the game. Tile and animal indexes are reset in the following situations:

A tile is generated and added in the game;

The game enters the idle state;

A chain is deselected either by being invalid (too short) or by being valid and finished; the selected tiles will be unselected and moved back to the unselected tiles layer;

The index reset for the tiles is done by resetting index of the tiles to the correct layer in the right order.

The index reset on the animals is similar. For example if an animal falls in the mud hole and another animals sits above him and the animal that sits above (logically) is usually of a lower index so it will sit beneath. To address this case any animal stuck in a mud hole is moved on a very low index so it will show beneath other animals.

Game element data, will be provided in a respective memory location, contains the data from which the game characteristics are defined. By way of example only, the data may identify the position of a tile and one or more attributes of the tile. One or more attributes may be provided. By way of example only, the attributes may be size, colour, character or the like of the tile. For example, the data comprises X (x coordinate information); Y (y coordinate information); a (where a is one of a set of numbers and each number represents a different character); The attribute data may not itself be stored with the game element data. It should be appreciated that the attributes mentioned are by way of example and any suitable attributes may be used in embodiments, dependent on the game.

The example above has numeric values to represent the character. For example the number 1 may mean a carrot. It should be appreciated that this is by way of example only and any other suitable method may be used to indicate the value or type of a particular attribute. In some embodiments, the data may have n bit where n represents each of the possible values of each of the possible attributes and 1 and 0 are used to indicate if the particular value of an attribute is present.

In some embodiments, a word or collection of letters may be used to indicate a value of the attributes. The attributes may be stored in an attribute data class. The attribute data (value object or VO) is stored in the model. An actor may be provided,

The actor accesses the data through a reference to an attribute data object. In other words, the tile actor will have a reference to the data associated with the character attribute a. Thus the actor 6 stores a reference to the attribute data. The actor provides a view function and may be part of the view function. The actor, in providing the view function requests from the model the information that it needs to generate an output representation.

In addition to the above described game model, tile model, lanes model and view function, some embodiments may further include a proxy. The proxy may be a system configured to replay the game and validate a score for the game.

For each game a random number (for example called random seed that comes from a server) may be used to generate the initial game board (for example the board of FIG. 3a). Each new game element in the game (for example animal types (second game elements), tile types (first game elements) and mud hole (obstacle game element) positions may be determined by the random seed. In order to validate a player's score at the end of the game, the player's valid actions (user input) will be sent to the proxy system along with the score generated by the game played. In some embodiments, the proxy may be a function (for example a java class) that will use the same random seed and the game model (in this example, translated in java) to replay the game exactly as the user played it, applying the same valid actions on the same board at the exact unit of time and calculates the score.

If the score generated by the proxy is different from the score generated by the game played by the player, then the game will be invalidated and the player will not be registered with that score. It will be appreciated that the score may be considered different if it doesn't match exactly in some embodiments. In other embodiment the scores should be in a range, for example + or −5%. The proxy may also look for a few methods of cheating, and if they are present the game will be invalidated and the player will receive an error.

The game client and the proxy may both use a class of predictive random, that uses the random seed and will produce the same sequence of numbers every time (for a specific seed). In this case, the game board may appear to be random, but the proxy can replicate the same board and replay the game again and validate the score.

It will be appreciated that the game element information of the foregoing may be attributes of a game element.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

It is also noted herein that while the above describes embodiments of the invention, there are several variations and modifications which may be made to the disclosed solution without departing from the scope of the present invention.

1. A system for providing a computer implemented game having a plurality of game elements which in use are displayed on display, said system comprising:
an input configured to receive an input from a user;
a first game part configured to be responsive to said input and configured to control a first part of a game area;
a second game part configured to be responsive to information from said first game part and configured to control a second part of the game area, said first part of said game area being different to said second part of said game area; and
a view function configured to perform a view function for the respective game parts to cause an image to displayed comprising said first and second game areas and game elements there on.

2. The system of claim 1 wherein the first and second game parts are game models.

3. The system of claim 1 wherein the first part of the game area has a plurality of a first game elements, said first game part configured to update game element information associated with at least one of the first game elements.

4. The system of claim 1 wherein the first game part is configured to determine if said input comprises a valid input and if so to update game element information associated with at least one first game element.

5. The system of claim 4 wherein a valid input comprises an input linking a plurality of first game elements in accordance with a set of rules.

6. The system of claim 1 wherein the first game part is configured to generate an output to said second game part responsive to a valid input, said output being dependent on one or more characteristics of the valid input.

7. The system of claim 1 wherein the second part of the game area has a plurality of a second game elements, said second game part configured to update game element information associated with the second game elements.

8. The system of claim 6 wherein the second game part is configured to update game element information associated with said second game elements in response to said output from said first game part.

9. The system of claim 6 wherein the view function is configured to cause a displayed image to be updated in response to an indication of the updated game element information from the second game part.

10. The system of claim 4 wherein the view function is configured to cause a displayed image to be updated in response to an indication of the updated game element information from the first game part.

11. The system of claim 1 wherein the first game part is further configured to generate a new first game element in response to the input.

12. The system of claim 1 wherein the second game part is further configured to generate a new second game element in response to the information from the first game part.

13. A method for providing a computer implemented game having a plurality of game elements which in use are displayed on display, said method comprising:
receiving an input from a user;
controlling a first part of a game area by a first game part in response to said input;
controlling a second part of the game area by a second game part in response to information from said first game part, where said first part of said game area being different to said second part of said game area; and
perform a view function for the respective game parts to cause an image to displayed comprising said first and second game areas and game elements there on.

14. The method of 13 wherein the first part of the game area has a plurality of a first game elements, the method further comprising:
updating game element information associated with at least one of the first game elements by the first game part.

15. The method of claim 13 further comprising:
determining by the first game part if said input comprises a valid input and if so to updating game element information associated with at least one first game element.

16. The method of claim 13 further comprising:
generating by the first game part an output to said second game part responsive to a valid input, said output being dependent on one or more characteristics of the valid input.

17. The method of claim 13 wherein the second part of the game area has a plurality of a second game elements, the method further comprising:
updating game element information associated with the second game elements by the second game part.

18. The method of claim 16, further comprising:
Updating by the second game part, game element information associated with said second game elements in response to said output from said first game part.

19. The method of claim 16, further comprising:
causing a displayed image to be updated in response to an indication of the updated game element information from the second game part.

20. The method of claim 14, further comprising:
causing a displayed image to be updated in response to an indication of the updated game element information from the first game part.

21. The method of claim 13, further comprising:
generating by the first game part a new first game element in response to the input.

22. The method of claim 16 further comprising:
generating by the second game part a new second game element in response to the output from the first game part.
